(19) United States
(12) Patent Application Publication
(10) Pub. No.: US 2023/0161277 A1
(43) Pub. Date: May 25, 2023

(54) TONER

(71) Applicant: CANON KABUSHIKI KAISHA, Tokyo (JP)

(72) Inventors: Yuta Komiya, Kanagawa (JP); Kosuke Fukudome, Tokyo (JP); Kenta Kamikura, Kanagawa (JP); Kozue Uratani, Shizuoka (JP)

(21) Appl. No.: 18/046,585

(22) Filed: Oct. 14, 2022

(30) Foreign Application Priority Data
Oct. 20, 2021 (JP) 2021-171643

(51) Int. Cl. G03G 9/08; G03G 9/093; G03G 9/087

(52) U.S. Cl. CPC G03G 9/0825; G03G 9/0827; G03G 9/08711; G03G 9/08728; G03G 9/08755; G03G 9/08764; G03G 9/09314; G03G 9/09357

(57) ABSTRACT

The toner comprises a toner particle that comprises a binder resin-containing core particle and a thermosetting resin-containing shell on the surface of the core particle, wherein the binder resin includes at least one of (i) a vinyl resin and a polyester resin and (ii) a hybrid resin in which a vinyl resin and a polyester resin are bonded; the polyester resin comprises in a main chain thereof a cyclic structure, and the content of the polyester resin in the tetrahydrofuran-soluble matter of the toner is at least 51 mass%; the vinyl resin comprises a prescribed monomer unit; the thermosetting resin is at least one resin selected from melamine resins, urea resins, and oxazoline group-bearing vinyl resins; and the average circularity of the toner is in a prescribed range.

### BACKGROUND OF THE INVENTION

### Field of the Invention

The present disclosure relates to the toner used in electrophotographic system-based image-forming devices.

### Description of the Related Art

Higher speeds and higher image qualities have been required in recent years of electrophotographic image-forming devices, e.g., copiers and printers. In addition, global efforts directed to reducing environmental impact are imposing even more severe demands with regard to increasing product energy savings and extending product life. Toner that responds to these demands must exhibit even greater enhancements in various properties and in particular must exhibit an even more enhanced low-temperature fixability from the standpoints of increasing the speed and further improving energy savings.

Reducing the softening temperature of the binder resin in toner is an example of a method for achieving low-temperature fixability in a toner. However, problems have occurred when the softening temperature of the binder resin is low, i.e., the heat-resistant storability of the toner is reduced and in particular toner-to-toner melt adhesion, known as blocking, occurs in high-temperature environments.

In response to such problems, Japanese Patent Application Laid-open No. 2019-040024 describes a pulverized toner for bringing about an enhanced toner low-temperature fixability and heat-resistant storability. This pulverized toner is a core-shell type in which the toner particle has a toner core and a shell layer coating the surface of the toner core, wherein the shell layer contains a thermosetting resin.

### SUMMARY OF THE INVENTION

The toner described in the aforementioned document has an improved heat-resistant storability due to the presence of the thermosetting resin layer at the toner surface. However, under severe conditions of extended use of a printer with a large load being placed on the toner for the purpose of high-speed image output, development members are susceptible to shaving by rubbing between the development members and protruded portions on the toner surface. It has thus been found that image defects (image streaking) caused by this development member shaving are produced by extended use as a result.

There is also a tendency for unevenness to readily be produced on pulverized toner such as the aforementioned toner. Although the presence of unevenness exercises a favorable action on the cleaning performance, the flowability is readily reduced and the generation of fogging is facilitated as a result.

The present disclosure provides a toner that solves the problems identified above. That is, the present disclosure provides a toner that exhibits an excellent low-temperature fixability and heat-resistant storability, while at the same time being able to achieve an inhibition of the image streaking caused by development member shaving and by deficient cleaning, and also being able to suppress fogging.

The present disclosure relates to a toner comprising a toner particle, the toner particle comprising
a core particle containing a binder resin, and
a shell containing a thermosetting resin on the surface of the core particle, wherein
   the binder resin comprises at least one of the following (i) and (ii):
      (i) a vinyl resin and a polyester resin,
      (ii) a hybrid resin in which a vinyl resin and a polyester resin are bonded;
   the polyester resin comprises in a main chain thereof a cyclic structure;
   a content of the polyester resin having the cyclic structure in a fraction having a molecular weight of at least 2000, as provided by fractionation by preparative GPC from the tetrahydrofuran-soluble matter of the toner, is at least 51 mass%;
   the vinyl resin comprises a monomer unit represented by the following formula (1) 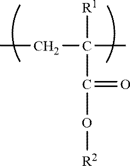
   where, in the formula (1), R¹ represents a hydrogen atom or methyl group, and R² represents a straight-chain alkyl group having 10 to 14 carbons;
   the thermosetting resin is at least one resin selected from the group consisting of a melamine resin, an urea resin, and a vinyl resin having an oxazoline group; and
   the toner has an average circularity of 0.920 to 0.965.

The present disclosure can provide a toner that exhibits an excellent low-temperature fixability and heat-resistant storability, while at the same time being able to achieve an inhibition of the image streaking caused by development member shaving and by deficient cleaning, and also being able to suppress fogging.

Further features of the present invention will become apparent from the following description of exemplary embodiments.

### DESCRIPTION OF THE EMBODIMENTS

Unless otherwise specified, descriptions of numerical ranges such as “from XX to YY” or “XX to YY” include the numbers at the upper and lower limits of the range. When numerical ranges are described in stages, the upper and lower limits of each of each numerical range may be combined arbitrarily.

The term “monomer unit” describes a reacted form of a monomeric material in a polymer, and one carbon-carbon bonded section in a principal chain of polymerized vinyl-based monomers in a polymer is given as one unit. The vinyl-based monomer can be represented by the following formula (Z).

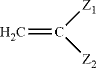

In formula (Z), Z₁ represents a hydrogen atom or alkyl group (preferably an alkyl group having 1 to 3 carbon atoms, or more preferably a methyl group), and Z₂ represents any substituent.

As noted in the document referenced above, a core-shell toner containing a thermosetting resin in the shell layer is effective for enhancing the heat-resistant storability of toner. However, aside from the heat-resistant storability of the toner, simply using such a core-shell toner is inadequate for bringing about an inhibition of fogging in combination with an excellent cleaning performance and an inhibition of image streaking caused by development member shaving. In particular, under severe conditions of extended use of a printer with a large load being placed on the toner for the purpose of high-speed image output, image streaking caused by development member shaving due to rubbing by the protruded portions on the toner surface with development members readily becomes substantial.

The present inventors carried out intensive investigations into the structure of a toner that, in addition to having an excellent heat-resistant storability, would be able to suppress the fogging caused by reduced flowability while maintaining the cleaning performance and inhibiting development member shaving even during printer use with a large load being placed on the toner.

Providing the toner particle surface with an uneven shape and thus enhancing the scraping performance by the cleaning blade is effective for obtaining an excellent cleaning performance. On the other hand, in order to suppress shaving of development members by the protruded portions of the toner particle surface, it is necessary to control — during rubbing by the toner particle with development members in a room temperature environment — the amount of deformation by which the toner deforms in the direction that relaxes the shape of the protruded portions versus the stress applied to the toner. In addition, in order to prevent toner that has been deformed by rubbing from being crushed by the stress, the viscoelasticity of the toner in a room temperature environment must be controlled to a high level.

The present inventors focused here on the polyester resin and the formula (1) monomer unit-containing vinyl resin in the binder resin in the core particle. Due to the large number of carbons, the end of the alkyl group in the long-chain alkyl group R² in formula (1) has a high degree of freedom. As a consequence, it is thought that the incorporation of the formula (1) monomer unit in the binder resin can generate a locally high mobility for the binder resin, for example, even in the temperature region at or below the glass transition point of the binder resin as a whole, such as a room temperature environment.

It is thought that as a result, when a large stress is applied to the toner particle when the toner particle rubs a development member, the amount of deformation — in which the toner particle deforms in the direction that relaxes the stress applied to a protruded portion on the toner particle — can thereby be made large and development member shaving can be suppressed.

In addition, the properties of the polyester resin can be readily controlled through the monomer composition, and the elastic modulus of the toner can be raised by increasing the rigidity of the binder resin by introducing a cyclic structure-bearing segment into the main chain. It is thought that toner crushing due to toner deformation can be inhibited by raising the elastic modulus of the toner. In addition, the molecular mobility is high when the toner melts and an excellent low-temperature fixability is then provided through an instantaneous plasticization of the toner as a whole.

Moreover, it is thought that, by controlling the average circularity of the toner, the generation of fogging can be suppressed because the flowability can be maintained, while achieving an excellent cleaning performance.

The present inventors discovered that the aforementioned problems can be solved by the toner described in the following.

The present disclosure relates to a toner comprising a toner particle, the toner particle comprising
a core particle containing a binder resin, and
a shell containing a thermosetting resin on the surface of the core particle, wherein
   the binder resin comprises at least one of the following (i) and (ii):
      (i) a vinyl resin and a polyester resin,
      (ii) a hybrid resin in which a vinyl resin and a polyester resin are bonded;
   the polyester resin has in a main chain thereof a cyclic structure;
   a content of the polyester resin having the cyclic structure in a fraction having a molecular weight of at least 2000, as provided by fractionation by preparative GPC from the tetrahydrofuran-soluble matter of the toner, is at least 51 mass%;
   the vinyl resin has a monomer unit represented by the following formula (1) 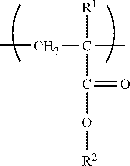
   wherein in formula (1), R¹ represents a hydrogen atom or methyl group, and R² represents a straight-chain alkyl group having 10 to 14 carbons;
   the thermosetting resin is at least one resin selected from the group consisting of a melamine resin, an urea resin, and a vinyl resin having an oxazoline group; and
   the toner has an average circularity of 0.920 to 0.965.

### Binder Resin

The binder resin contained in the toner particle contains at least one of
(i) a vinyl resin and a polyester resin, and
(ii) a hybrid resin in which a vinyl resin and a polyester resin are bonded.

Both (i) and (ii) may be incorporated. For example, the binder resin may contain a vinyl resin and a polyester resin. For example, the binder resin may contain a vinyl resin and a polyester resin, and a hybrid resin may be formed by bonding at least a portion or all of the vinyl resin with at least a portion or all of the polyester resin. For example, the binder resin may contain a vinyl resin plus a polyester resin plus a hybrid resin, or may contain a vinyl resin plus a hybrid resin, or may contain a polyester resin plus a hybrid resin. The bonding can be exemplified by covalent bonding.

### Vinyl Resin

The vinyl resin refers to a polymer of vinyl group-containing monomer (referred to hereafter as vinyl monomer). The vinyl resin can be exemplified by styrene-acrylic resins, styrene resins, acrylic resins, and so forth.

The vinyl resin has a monomer unit represented by the following formula (1).

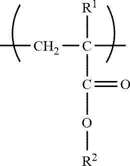

In formula (1), R¹ represents a hydrogen atom or methyl group and R² represents a straight-chain alkyl group having from 10 to 14 carbons. The end of the alkyl group in the monomer unit with formula (1) (hereafter also referred to as the “long-chain acrylate unit”) has a high degree of freedom.

As previously noted, it is thought that as a consequence the resin having a long-chain acrylate unit can exhibit a locally high mobility for the resin — even in a temperature region lower than the glass transition point of the resin as a whole. As a result, development member shaving can be suppressed because the deformation rate for the toner is increased. The R² in formula (1) preferably has 11 to 13 carbons and more preferably has 12 carbons.

The content of the formula (1) monomer unit in the vinyl resin is preferably from 1.0 mass% to 15.0 mass%. From 3.0 mass% to 12.0 mass% is more preferred. A uniform dispersion of the long-chain acrylate unit in the binder resin as a whole can be brought about by using at least 1.0 mass%.

On the other hand, the presence of the long-chain alkyl ester in the formula (1) monomer unit tends to reduce the glass transition point of the vinyl resin. Due to this, the content of the formula (1) monomer unit in the vinyl resin is preferably not more than 15.0 mass% taking into account the heat-resistant storability.

Acrylic polymerizable monomer (vinyl monomer) for the synthesis of the styrene-acrylic resin can be exemplified by methacrylate ester derivatives such as methyl methacrylate, ethyl methacrylate, isopropyl methacrylate, n-butyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate, and by acrylate ester derivatives such as methyl acrylate, ethyl acrylate, isopropyl acrylate, n-butyl acrylate, isobutyl acrylate, t-butyl acrylate, n-octyl acrylate, 2-ethylhexyl acrylate, stearyl acrylate, lauryl acrylate, and phenyl acrylate. The use of n-butyl acrylate is particularly preferred. A single one of these may be used by itself or two or more may be used in combination.

Styrene polymerizable monomer (vinyl monomer) for the synthesis of the styrene-acrylic resin can be exemplified by styrene and styrene derivatives, such as styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene, with the use of styrene, which is a hydrophobic monomer, being preferred. A single one of these may be used by itself or two or more may be used in combination.

The content in the vinyl resin of monomer units provided by styrene polymerizable monomer is preferably 50.0 to 98.0 mass% and more preferably 70.0 to 90.0 mass%. The content in the vinyl resin of monomer units provided by acrylic polymerizable monomer is preferably 1.0 to 30.0 mass% and more preferably 2.0 to 20.0 mass%.

### Polyester Resin

The polyester resin has a cyclic structure in its main chain. This polyester resin having the cyclic structure (cyclic structure-bearing polyester resin) is preferably an amorphous polyester resin.

Monomers that can be used to produce the amorphous polyester resin can be exemplified by heretofore known dibasic or at least tribasic carboxylic acids and dihydric or at least trihydric alcohols. Specific examples of these monomers are provided below. The polyester resin is a condensation polymer of an alcohol component and a carboxylic acid component, and preferably at least one of the alcohol component and carboxylic acid component contains cyclic structure-bearing monomer.

Cyclic structure-bearing alcohols can be exemplified by alicyclic diols (e.g., 1,4-cyclohexanedimethanol), bisphenols (e.g., bisphenol A), alkylene oxide (e.g., ethylene oxide, propylene oxide) adducts on alicyclic diols, alkylene oxide (e.g., ethylene oxide, propylene oxide) adducts on bisphenols (e.g., bisphenol A), and isosorbide.

Alcohols having a straight-chain structure can be exemplified by alkylene diols (e.g., 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol) and by alkylene ether glycols (trimethylene glycol, tetramethylene glycol).

The alkyl moiety of the alkylene diol and alkylene ether glycol may be straight chain or branched. An alkylene diol having a branched structure can also preferably be used.

The cyclic structure-bearing carboxylic acids can be exemplified by dibasic carboxylic acids such as phthalic acid, isophthalic acid, terephthalic acid, and dodecenylsuccinic acid, and their anhydrides.

Carboxylic acids having a straight-chain structure can be exemplified by dibasic carboxylic acids such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid, and their anhydrides and lower alkyl esters.

Aliphatic unsaturated dicarboxylic acids can be exemplified by maleic acid, fumaric acid, itaconic acid, and citraconic acid and their lower alkyl esters and anhydrides.

Additional examples are 1,2,4-benzenetricarboxylic acid and 1,2,5-benzenetricarboxylic acid and their anhydrides and lower alkyl esters.

A single one of these may be used by itself or two or more may be used in combination.

A double bond-bearing aliphatic diol may also be used. This double bond-bearing aliphatic diol can be exemplified by the following compounds: 2-butene-1,4-diol, 3-hexene-1,6-diol, and 4-octene-1,8-diol.

The at least trihydric alcohol can be exemplified by glycerol, trimethylolethane, trimethylolpropane, and pentaerythritol.

A single one of these may be used by itself or two or more may be used in combination.

The polyester resin may form a hybrid resin by bonding with a vinyl resin. The formation of a hybrid resin by bonding between a polyester resin and vinyl resin is preferred. The formation of the hybrid resin, by increasing the dispersity of the vinyl resin in the binder resin, can effectively suppress member shaving.

The method for producing the hybrid resin in which vinyl resin and polyester resin are bonded can be exemplified by carrying out polymerization using a compound (referred to hereafter as a “bireactive compound”) that can react with either and any of the monomers that produce the two resins.

This bireactive compound can be exemplified, from among monomers for condensation polymerization-type resins and monomers for addition polymerization-type resins, by fumaric acid, acrylic acid, methacrylic acid, citraconic acid, maleic acid, and dimethyl fumarate. Among these, the use is preferred of fumaric acid, acrylic acid, and methacrylic acid.

The content of the cyclic structure-bearing polyester resin in the fraction having a molecular weight of at least 2,000, as provided by fractionation by preparative GPC from the tetrahydrofuran-soluble matter of the toner, must be at least 51 mass%.

By having the polyester resin content be at least 51 mass%, the rigidity of the binder resin can be increased, and the elastic modulus of the toner can be raised, due to the cyclic structure-bearing segment contained in the molecular chain of the polyester resin. It is thought that raising the elastic modulus of the toner provides the ability to inhibit toner crushing arising from toner deformation. The content of the cyclic structure-bearing polyester resin in the fraction having a molecular weight of at least 2,000, as provided by fractionation by preparative GPC from the tetrahydrofuran (THF)-soluble matter of the toner, is preferably from 60 mass% to 80 mass% and more preferably from 65 mass% to 75 mass%.

The content of the vinyl resin in the fraction having a molecular weight of at least 2,000, as provided by fractionation by preparative GPC from the tetrahydrofuran-soluble matter of the toner, is preferably from 1 mass% to 49 mass%, more preferably from 3 mass% to 25 mass%, and still more preferably from 5 mass% to 12 mass%. This range provides an excellent heat-resistant storability for the toner and enables suppression of the image streaking caused by member shaving.

The content ratio on a mass basis between the cyclic structure-bearing polyester resin and the vinyl resin, in the fraction having a molecular weight of at least 2,000 as provided by fractionation by preparative GPC from the THF-soluble matter of the toner, is preferably in the range of polyester resin: vinyl resin = 60:40 to 99:1. When this range is implemented, coexistence between the inhibition of development member shaving and the inhibition of toner crushing is then even more readily achieved. Polyester resin: vinyl resin = 85:15 to 95:5 is more preferred.

The content in the polyester resin of monomer unit provided by cyclic structure-bearing monomer is preferably 50 mass% to 100 mass%, more preferably 80 mass% to 100 mass%, and still more preferably 90 mass% to 100 mass%. The polyester resin preferably is a condensation polymer of a cyclic structure-bearing alcohol and cyclic structure-bearing carboxylic acid.

### Thermosetting Resin

The thermosetting resin is a crosslinked resin that cures by forming a network structure by heat-induced crosslinking. The toner contains a thermosetting resin in a shell on the core particle surface. The thermosetting resin is at least one resin selected from the group consisting of melamine resins, urea resins, and vinyl resins having an oxazoline group (oxazoline group-bearing vinyl resins). In light of the aforementioned definition, oxazoline group-bearing vinyl resins are treated in the present disclosure as thermosetting resins.

In addition, the shell may contain a plurality of thermosetting resins in addition to the aforementioned thermosetting resin. This additional thermosetting resin can be exemplified by sulfonamide resins, glyoxal resins, guanamine resins, aniline resins, polyimide resins, and xylene resins.

In addition, the shell may contain a plurality of thermoplastic resins in addition to the aforementioned thermosetting resin. This thermoplastic resin can be exemplified by styrene resins, acrylic acid resins, olefin resins, vinyl chloride resins, polyvinyl alcohol, vinyl ether resins, N-vinyl resins, polyester resins, polyamide resins, and urethane resins. Copolymers of each of these resins, i.e., copolymer provided by the introduction of a freely selected repeat unit into the aforementioned resins, may also be used.

The content in the shell of the at least one selection from the group consisting of melamine resins, urea resins, and oxazoline group-bearing vinyl resins is preferably 50 mass% to 100 mass%, more preferably 80 mass% to 100 mass%, and still more preferably 90 mass% to 100 mass%.

The melamine resin is preferably a methylolmelamine resin, hexamethylolmelamine resin, or methoxymethylolmelamine resin.

The urea resin is preferably an alkylated urea resin or a methylolated urea resin.

The oxazoline group-bearing vinyl resin is a vinyl resin that contains a monomer unit that contains the oxazoline group. The monomer represented by the following formula (5) is an example of monomer that forms the oxazoline group-bearing monomer unit. 2-Vinyl-2-oxazoline is more preferred.

The oxazoline group-bearing vinyl resin is preferably a vinyl resin that contains a monomer unit that contains the oxazoline group and more preferably has a monomer unit provided by the vinyl polymerization of 2-vinyl-2-oxazoline.

The oxazoline group-bearing vinyl resin preferably has the monomer unit given by the following formula (5B), as provided by the monomer given by the following formula (5).

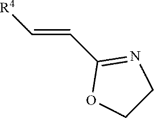

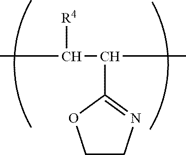

In formulas (5) and (5B), R⁴ represents a hydrogen atom or an alkyl group. The alkyl group represented by R⁴, for example, is preferably an alkyl group having from 1 to 6 carbon atoms, with the methyl group, ethyl group, and isopropyl group being more preferred. R⁴ is more preferably a hydrogen atom.

2-Vinyloxazoline is a favorable example of a vinyl compound represented by formula (5).

A more favorable example of the oxazoline group-bearing vinyl resin is a copolymer of a formula (5) vinyl compound with a vinyl compound other than the formula (5) vinyl compound.

The vinyl compound other than the formula (5) vinyl compound can be exemplified by ethylene, propylene, butadiene, vinyl chloride, (meth)acrylic acid, (meth)acrylate esters, acrylonitrile, and styrene.

The (meth)acrylate ester is preferably an alkyl (meth)acrylate, and the number of carbons in the alkyl group is preferably 1 to 4. The alkyl (meth)acrylate is preferably methyl (meth)acrylate or ethyl (meth)acrylate and is more preferably methyl methacrylate.

The vinyl resin is preferably a copolymer between a formula (5) vinyl compound and an alkyl (meth)acrylate. It is more preferably a copolymer between a formula (5) vinyl compound and methyl methacrylate.

The content in the vinyl resin of the structure with formula (5B) is preferably 5 mass% to 98 mass% and is more preferably 20 mass% to 95 mass%.

For example, an aqueous solution of an oxazoline group-containing polymer (“Epocros (registered trademark) WS series”, Nippon Shokubai Co., Ltd.) can be used to form the shell using an oxazoline group-bearing vinyl resin. “Epocros WS-300” and “Epocros WS-700” each contain a copolymer of 2-vinyl-2-oxazoline and an alkyl methacrylate.

### Average Circularity of the Toner

The average circularity of the toner must be from 0.920 to 0.965. By having the average circularity of the toner be at least 0.920, a satisfactory toner flowability is obtained and the charging performance is enhanced, and as a consequence image problems (fogging) in which toner develops into non-image areas can be suppressed.

On the other hand, by having the average circularity of the toner be not more than 0.965, scrape-off by the cleaning blade can be improved due to the uneven shape of the toner particle surface, and as a consequence image problems (image streaking) caused by poor cleaning can be suppressed.

The average circularity of the toner is preferably from 0.940 to 0.962 and is more preferably from 0.945 to 0.955. The average circularity of the toner can be controlled using the method by which the toner is produced. The method for measuring the average circularity of the toner is described below.

### Ester Compounds With Formulas (2) to (4)

The toner particle preferably contains at least one ester compound selected from the group consisting of ester compounds represented by the following formula (2), ester compounds represented by the following formula (3), and ester compounds represented by the following formula (4).

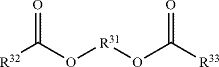

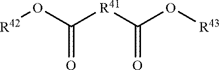

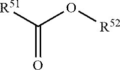

In formulas (2), (3), and (4), R³¹ and R⁴¹ each independently represent alkylene groups having from 2 to 8 carbons, and R³², R³³, R⁴², R⁴³, R⁵¹, and R⁵² each independently represent a straight-chain alkyl group having from 14 to 24 (preferably from 16 to 24 and more preferably from 17 to 22) carbons. The ester compounds with formulas (2) to (4) exhibit a high structural analogy and high affinity with the monomer unit with formula (1) in the vinyl resin, and as a consequence readily increase the compatibility during melting and can provide an excellent low-temperature fixability.

Examples of the compound represented by Formula (2) include ethylene glycol dipalmitate, ethylene glycol distearate, ethylene glycol dieicosanate, ethylene glycol dibehenate, ethylene glycol ditetracosanate, butanediol distearate, butanediol dibehenate, hexanediol distearate, hexanediol dibehenate, octanediol distearate and octanediol dibehenate.

Examples of the compound represented by Formula (3) include distearyl succinate, dibehenyl succinate, distearyl adipate, dibehenyl adipate, distearyl suberate, dibehenyl suberate, distearyl sebacate and dibehenyl sebacate.

Examples of the compound represented by Formula (4) include palmityl palmitate, stearyl palmitate, behenyl palmitate, palmityl stearate, stearyl stearate, behenyl stearate, palmityl behenate, stearyl behenate and behenyl behenate.

Among these ester compounds, at least one selection from the group consisting of ethylene glycol distearate, ethylene glycol dibehenate, dibehenyl sebacate, stearyl behenate, behenyl behenate, and behenyl stearate is preferred for the ester compound from the standpoint of the melting point and molecular weight being in the preferred ranges described below and from the standpoint of increasing the compatibility with the formula (1) monomer unit upon melting.

The melting point of the ester compound is preferably from 60° C. to 90° C. and more preferably from 65° C. to 85° C. The molecular weight of the ester compound is preferably from 500 to 900 and more preferably from 550 to 850.

The content of the ester compound is preferably from 1.0 parts by mass to 40.0 parts by mass, more preferably from 3.0 parts by mass to 30.0 parts by mass, and yet more preferably from 5.0 parts by mass to 25.0 parts by mass, relative to 100.0 parts by mass of the binder resin.

### SP Value

Using SPm (J/cm³)^{½} for the SP value of the monomer unit represented by formula (1) and using SPw (J/cm³)^{½} for the SP value of the ester compound, SPm is preferably from 18.00 to 19.00 and SPm and SPw preferably satisfy the following formula (a).

$$\left|\text{SPm-SPw}\right| \leq 1.50$$

The monomer unit takes on a suitable polarity by having SPm be from 18.00 to 19.00, and due to this a high level of affinity with the vinyl resin can be retained. As a result, a large range of toner deformation can be provided in the temperature region at and below the glass transition point of the vinyl resin as a whole, as a consequence of which development member shaving can be more effectively suppressed. SPm is preferably 18.50 to 18.90.

SPw is preferably 17.00 to 18.50 and more preferably 17.40 to 18.20.

Having | SPm - SPw | ≤ 1.50 provides for a high affinity between the ester compound and formula (1) monomer unit as described above, as a consequence of which the compatibility upon melting is readily increased and an even better low-temperature fixability can be realized. | SPm - SPw | is preferably not more than 1.30 and more preferably not more than 1.20. While the lower limit is not particularly limited, it is preferably greater than or equal to 0.00, or greater than or equal to 0.30, or greater than or equal to 0.50.

SPw, which is the SP value of the ester compound, is determined after Fedors. SPm, which is the SP value of the monomer unit, is determined, proceeding as described below, in accordance with the calculation procedure proposed by Fedors.

Here, the monomer unit constituting the vinyl resin (when the polymer constituting this resin is produced by the polymerization reaction of vinyl monomer) denotes the molecular structure in a state in which the double bond of the vinyl monomer has been opened by polymerization.

For example, to calculate the SP value (SPm) (J/cm³)^{½} of the monomer unit, the vaporization energy (Δei) (J/mol) and molar volume (Δvi) (cm³/mol) of the atoms and atomic groups in the molecular structure of this monomer unit are determined from the tables provided in “Polym. Eng. Sci., 14(2), 147-154 (1974)”, and the calculation is performed using the following formula.

$$\text{SPm} = {\left(\sum Δ \text{ei} / \sum Δ \text{vi}\right)}^{1 / 2}$$

The unit for the SP value is (J/cm³)^{½}, but this can be converted to the (cal/cm³)^{½} unit using 1 (cal/cm³)^{½} = 2.046 × 10⁻³ (J/cm³)^{½}.

The loss elastic modulus G″ (Pa) of the toner at 30° C. according to dynamic viscoelastic measurement is preferably from 1.0 × 10⁷ to 7.0 × 10⁷ and is more preferably from 1.0 × 10⁷ to 6.0 × 10⁷. Control into the indicated range provides an excellent heat-resistant storability for the toner and can also suppress the image streaking caused by member shaving.

### Crystalline Polyester Resin

The toner particle preferably further comprises a crystalline polyester resin. The polyester resin should exhibit crystallinity, but is not otherwise limited, and known crystalline polyester resins can be used. The occurrence of crystallinity indicates that the endothermic curve obtained by DSC has a melting point, i.e., a distinct endothermic peak during heating. This distinct endothermic peak refers to a peak with a full width at half maximum within 15° C. in the endothermic curve when heating is carried out at a ramp rate of 10° C./min.

The crystalline polyester resin specifically refers to a resin that exhibits crystallinity, from among polyester resins obtained by a polymerization reaction between at least dibasic carboxylic acid (polybasic carboxylic acid) monomer and at least dihydric alcohol (polyhydric alcohol) monomer.

The crystalline polyester resin can be formed proceeding as for the above-described amorphous polyester resin, using a known esterification catalyst and using polybasic carboxylic acid monomer and polyhydric alcohol monomer that can be used for the synthesis of crystalline polyester resin, as follows.

Polybasic carboxylic acid monomer that can be used for the synthesis of crystalline polyester resin can be exemplified by saturated aliphatic dicarboxylic acids, e.g., oxalic acid, malonic acid, succinic acid, adipic acid, sebacic acid, azelaic acid, n-dodecylsuccinic acid, 1,10-decanedicarboxylic acid (dodecanedioic acid), and 1,12-dodecanedicarboxylic acid (tetradecanoic acid); alicyclic dicarboxylic acids such as cyclohexanedicarboxylic acid; aromatic dicarboxylic acids such as phthalic acid, isophthalic acid, and terephthalic acid; at least tribasic polybasic carboxylic acids such as trimellitic acid and pyromellitic acid; and the anhydrides and C₁₋₃ alkyl esters of these carboxylic acid compounds.

A single one of these may be used by itself or two or more may be used in combination.

Polyhydric alcohol monomer that can be used to synthesize crystalline polyester resin can be exemplified by aliphatic diols, e.g., ethylene glycol, diethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, neopentyl glycol, and 1,4-butenediol, and by at least trihydric polyhydric alcohols such as glycerol, pentaerythritol, trimethylolpropane, and sorbitol.

A single one of these may be used by itself or two or more may be used in combination.

Among the polyhydric alcohol monomers listed above, the use of ethylene glycol as the polyhydric alcohol monomer is preferred from the standpoint of raising the compatibility with the formula (1) unit upon melting.

In addition, among the polybasic carboxylic acid monomers listed above, the use of adipic acid, sebacic acid, azelaic acid, n-dodecylsuccinic acid, or 1,10-decanedicarboxylic acid (dodecanedioic acid) is preferred from the standpoints of increasing the crystallinity of the crystalline polyester resin and enhancing the heat-resistant storability.

From the standpoint of obtaining an excellent low-temperature fixability, the content of the crystalline polyester resin in the toner is preferably from 1.0 mass% to 30.0 mass% and is more preferably from 5.0 mass% to 20.0 mass%. A satisfactory low-temperature fixability is obtained when the content is at least 1 mass%.

The molecular chains of crystalline polyester are oriented with a certain regularity. Due to this, a property of crystalline polyester, which is caused by the orientation, is brittleness and a susceptibility to cracking. When the content is not more than 30 mass%, member contamination caused by toner cracking can be suppressed and image defects (image streaking) can be suppressed as a consequence.

The content of the crystalline polyester resin, per 100 mass parts of the binder resin, is preferably 1.0 mass parts to 30.0 mass parts, more preferably 5.0 mass parts to 25.0 mass parts, and still more preferably 10.0 mass parts to 20.0 mass parts.

The crystalline polyester resin preferably has a monomer unit represented by the following formula (A) and a monomer unit represented by the following formula (B). The n in formula (B) represents an integer of from 4 to 14 (preferably 6 to 12 and more preferably 8 to 12).

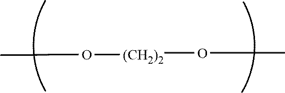

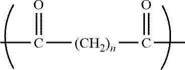

### Release Agent

The toner particle may contain, as a release agent, a known wax other than the ester compound that has been specified in the preceding.

The release agent can be exemplified by petroleum waxes as represented by paraffin waxes, microcrystalline waxes, and petrolatum, and derivatives thereof; montan wax and derivatives thereof; hydrocarbon waxes provided by the Fischer-Tropsch method, and derivatives thereof; polyolefin waxes as represented by polyethylene, and derivatives thereof; and natural waxes as represented by carnauba wax and candelilla wax, and derivatives thereof. These derivatives also include oxides and block copolymers and graft modifications with vinyl monomer. A single one of these by itself or combinations of these may be used.

The content of the non-ester-compound release agent, per 100 mass parts of the binder resin, is preferably 0.1 to 20 mass parts and more preferably 1 to 10 mass parts.

### Colorant

The toner particle may contain a colorant. The known magnetic bodies and pigments and dyes in the colors of black, yellow, magenta, and cyan as well as in other colors may be used without particular limitation as the colorant.

The black colorant can be exemplified by black pigments such as carbon black.

The yellow colorant can be exemplified by yellow pigments and yellow dyes, e.g., monoazo compounds, disazo compounds, condensed azo compounds, isoindolinone compounds, benzimidazolone compounds, anthraquinone compounds, azo metal complexes, methine compounds, and allylamide compounds.

Specific examples are C. I. Pigment Yellow 74, 93, 95, 109, 111, 128, 155, 174, 180, and 185 and C. I. Solvent Yellow 162.

The magenta colorants can be exemplified by magenta pigments and magenta dyes, e.g., monoazo compounds, condensed azo compounds, diketopyrrolopyrrole compounds, anthraquinone compounds, quinacridone compounds, basic dye lake compounds, naphthol compounds, benzimidazolone compounds, thioindigo compounds, and perylene compounds.

Specific examples are C. I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, 238, 254, and 269, and C. I. Pigment Violet 19.

The cyan colorants can be exemplified by cyan pigments and cyan dyes, e.g., copper phthalocyanine compounds and derivatives thereof, anthraquinone compounds, and basic dye lake compounds.

Specific examples are C. I. Pigment Blue 1, 7, 15, 15:1, 15:2, 15:3, 15:4, 60, 62, and 66.

The colorant content, considered per 100.0 mass parts of the binder resin or polymerizable monomer, is preferably from 1.0 mass parts to 20.0 mass parts.

In addition, the toner may also be made into a magnetic toner through the incorporation of a magnetic material. In this case, the magnetic material may also function as a colorant.

The magnetic material can be exemplified by iron oxides as represented by magnetite, hematite, and ferrite; metals as represented by iron, cobalt, and nickel; alloys of these metals with a metal such as aluminum, cobalt, copper, lead, magnesium, tin, zinc, antimony, beryllium, bismuth, cadmium, calcium, manganese, selenium, titanium, tungsten, and vanadium; and mixtures thereof.

When a magnetic material is used as the colorant, the magnetic material content is preferably from 30.0 mass parts to 100.0 mass parts per 100.0 mass parts of the binder resin.

### Charge Control Agent

The toner may contain a charge control agent. A known charge control agent can be used as the charge control agent without particular limitation.

Specifically, positive charge control agents can be exemplified by quaternary ammonium salts and polymeric compounds that have a quaternary ammonium salt in side chain position; guanidine compounds; pyridine compounds; nigrosine compounds; and imidazole compounds.

Negative charge control agents can be exemplified by metal compounds of aromatic carboxylic acids such as salicylic acid, alkylsalicylic acids, dialkylsalicylic acids, naphthoic acid, and dicarboxylic acids, and polymers and copolymers that have this metal compound of an aromatic carboxylic acid; polymers and copolymers that have a sulfonic acid group, sulfonate salt group, or sulfonate ester group; metal salts and metal complexes of azo dyes and azo pigments; boron compounds; silicon compounds; and calixarene.

A quaternary ammonium salt or a polymer compound having a quaternary ammonium salt in side chain position is preferably used for the charge control agent. The content of the charge control agent in the toner is preferably from 0.01 mass% to 5.00 mass%.

### External Additive

The toner may contain an external additive. The heretofore known external additives may be used without particular limitation as the external additive. Specific examples are inorganic fine particles, e.g., silica particles and metal oxides (more specifically, alumina, titanium oxide, magnesium oxide, zinc oxide, strontium titanate, barium titanate, and so forth); organic fine particles, e.g., of vinyl resin, silicone resin, melamine resin, and so forth; and organic-inorganic composite fine particles.

In addition, the external additive may be subjected to a surface treatment. Treatment agents such as silicone varnishes, various modified silicone varnishes, unmodified silicone oils, various modified silicone oils, silane compounds, silane coupling agents, other organosilicon compounds, and organotitanium compounds may be used individually or in combination as the surface treatment agent.

The content of the external additive in the toner is preferably from 0.1 mass parts to 5.0 mass parts per 100 mass parts of the toner particle.

The toner preferably contains a crosslinked resin fine particle as an external additive. That is, the toner preferably contains a toner particle and a crosslinked resin fine particle. Among particles used as external additives, crosslinked resin fine particles have a relatively hard surface. As a consequence, a crosslinked resin fine particle functions as a spacer that suppresses the embedding or burying of external additive in the toner particle. As a result, image defects (fogging) caused by a reduced toner charging performance can be more effectively suppressed, even during long-term use.

Styrenic monomer for the synthesis of the crosslinked resin fine particle can be exemplified by styrene, alkylstyrenes, hydroxystyrenes, and halogenated styrenes. The alkyl styrenes can be exemplified by α-methylstyrene, m-methylstyrene, p-methylstyrene, p-ethylstyrene, and 4-t-butylstyrene. The hydroxystyrenes can be exemplified by p-hydroxystyrene and m-hydroxystyrene. The halogenated styrenes can be exemplified by α-chlorostyrene, o-chlorostyrene, m-chlorostyrene, and p-chlorostyrene. Styrene is preferred for the styrenic monomer in support of facile synthesis of the prescribed crosslinked polymer.

Acrylic acid-type monomer for the synthesis of the crosslinked resin fine particle can be exemplified by (meth)acrylic acid, (meth)acrylamide, (meth)acrylonitrile, alkyl (meth)acrylate esters, and hydroxyalkyl (meth)acrylate esters.

The alkyl (meth)acrylate esters can be exemplified by methyl (meth)acrylate, ethyl (meth)acrylate, n-propyl (meth)acrylate, isopropyl (meth)acrylate, n-butyl (meth)acrylate, isobutyl (meth)acrylate, and 2-ethylhexyl (meth)acrylate. The hydroxyalkyl (meth)acrylate esters can be exemplified by 2-hydroxyethyl (meth)acrylate, 3-hydroxypropyl (meth)acrylate, 2-hydroxypropyl (meth)acrylate, and 4-hydroxybutyl (meth)acrylate.

Alkyl (meth)acrylate esters are preferred for the acrylic acid-type monomer in support of facile synthesis of the crosslinked resin fine particle, with methyl methacrylate being more preferred.

Crosslinking agents having two or more unsaturated bonds for synthesis of the crosslinked resin fine particle can be exemplified by the following: N,N′-methylenebisacrylamide, divinylbenzene, ethylene glycol diacrylate, ethylene glycol dimethacrylate, diethylene glycol diacrylate, tetraethylene glycol diacrylate, polyethylene glycol diacrylate, 1,4-butanediol diacrylate, 1,6-hexanediol diacrylate, tripropylene glycol diacrylate, trimethylolpropane triacrylate, pentaerythritol triacrylate, pentaerythritol tetraacrylate, 1,4-butanediol dimethacrylate, and 1,6-hexanediol dimethacrylate.

Divinylbenzene is preferred for the crosslinking agent having two or more unsaturated bonds in order to continuously form a higher quality image.

The crosslinked resin fine particle is preferably a fine particle of a styrene-acrylic resin that has been crosslinked by a crosslinking agent. Moreover, in order to continuously form a high-quality image, the crosslinked resin fine particle preferably contains a polymer of styrene, alkyl (meth)acrylate, and divinylbenzene as a constituent resin. For the same reason, the crosslinked resin fine particle more preferably contains only a polymer of styrene, alkyl (meth)acrylate, and divinylbenzene as its constituent resin, and the crosslinked resin fine particle even more preferably contains only a polymer of styrene, methyl methacrylate, and divinylbenzene as its constituent resin.

The crosslinked resin fine particle contains preferably 5 to 40 mass% and more preferably 10 to 30 mass% of monomer unit provided by styrene. The crosslinked resin fine particle contains preferably 20 to 90 mass% and more preferably 50 to 70 mass% of monomer unit provided by alkyl (meth)acrylate. The crosslinked resin fine particle contains preferably 5 to 40 mass% and more preferably 10 to 30 mass% of monomer unit provided by divinylbenzene.

The crosslinked resin fine particle has a number-average primary particle diameter of preferably from 80 nm to 250 nm and more preferably from 100 nm to 150 nm.

### Toner Production Methods

Known methods, e.g., suspension polymerization, dissolution suspension, emulsion aggregation, pulverization, and so forth, can be used to produce the toner, but there is no limitation to these. The toner is a toner comprising a core particle containing a binder resin (a binder resin-containing core particle), and a shell on the surface of the core particle. A production method is preferred in which the core particle is prepared by a production method as described in the proceeding, followed by formation of the shell from the outside. In a more preferred production method in this vein, the core particle is produced by pulverization or emulsion aggregation and the shell is then formed from the outside in an aqueous system. The shell need not coat the entire core particle, and regions may be present where the core particle is exposed.

### Method for Producing the Core Particle

An example of the pulverization method is described in the following. The binder resin is first mixed with optional internal additives (for example, at least one of colorant, release agent, charge control agent, and magnetic powder). The obtained mixture is subjected to melt-kneading. The resulting melt-kneaded material is then pulverized and the resulting pulverizate is classified. A core particle having the desired particle diameter is obtained as a result.

### Shell Formation Method

The core particle and shell material (for example, an aqueous solution of an oxazoline group-bearing vinyl resin) are added to an aqueous medium (for example, deionized water).

The shell material (for example, an oxazoline group-bearing vinyl resin dissolved in an aqueous medium) attaches to the core particle surface in the liquid. In order to bring about a uniform attachment of the shell material to the core particle surface, the core particles are preferably highly dispersed in the shell material-containing liquid. In order to bring about a high level of dispersion of the core particles in the liquid, a surfactant may be added to the liquid and the liquid may be stirred using a powerful stirrer (for example, a “HiVis Disper Mixer” from the PRIMIX Corporation).

A basic substance (for example, an aqueous ammonia solution) is then also added to the aqueous medium. The amount of the ring-unopened oxazoline group contained in the toner can be adjusted by adjusting the amount of addition of the basic substance.

Then, while stirring the liquid containing the shell material and so forth, the temperature is raised at a prescribed rate (for example, at a rate selected from 0.1° C./min to 3° C./min) to a prescribed holding temperature (for example, a temperature selected from 45° C. to 85° C. (preferably from 50° C. to 60° C.)). A ring-opening agent and/or shell material (for example, an aqueous solution of oxazoline group-bearing vinyl resin) may be added during this temperature ramp up. In addition, a ring-opening agent and/or shell material (for example, an aqueous solution of oxazoline group-bearing vinyl resin) may be added after the completion of temperature ramp up (after the prescribed holding temperature has been reached).

After the completion of the temperature ramp up, the temperature of the liquid is held for a prescribed period of time (for example, for a time selected from 30 minutes to 4 hours) at the aforementioned holding temperature while stirring. The shell layer forms during the period in which the liquid temperature is being held at the higher temperature (or during the temperature ramp up). It is thought that a reaction (shell attachment) develops between the core particle and the shell material. For example, it is thought that the oxazoline group in the shell material undergoes ring-opening through a reaction with functional groups present on the surface of the binder resin that constitutes the toner core, and in combination with this crosslinked structures originating with the ring-opened oxazoline group are formed within the shell layer.

The formation of the shell on the core particle surface in the liquid yields a dispersion of toner particles.

After this shell formation, the toner particle dispersion is neutralized using, for example, sodium hydroxide. The toner particle dispersion is then cooled to, for example, normal temperature (approximately 25° C.). The toner particle dispersion is subsequently filtered using, for example, a Buchner funnel. This results in separation (solid-liquid separation) of the toner particles from the liquid to yield a toner particle wet cake.

The elements and step sequence in this shell production method may each be freely altered in conformity to, e.g., the constitution and properties required of the toner. For example, the shell material may be added to the liquid all at once or may be added divided into multiple additions. Moreover, when a material (for example, the shell material) is reacted in a liquid, the material may be reacted in the liquid for a prescribed period of time after the material has been added to the liquid, or the material may be added to the liquid over an extended period of time and the material in the liquid may be reacted while adding the material to the liquid.

The content of the shell, per 100 mass parts of the core particle, is preferably from 1.0 mass parts to 10.0 mass parts and is more preferably from 3.0 mass parts to 7.0 mass parts.

The methods used to measure the values of the various properties are described in the following.

Proportions of the Polyester Resin and Vinyl Resin in the Fraction Having a Molecular Weight of at Least 2,000 as Provided by Fractionation by Preparative GPC from the THF-Soluble Matter of the Toner

The toner is dissolved in tetrahydrofuran (THF) and the solvent is distillatively removed under reduced pressure from the resulting soluble component to obtain the tetrahydrofuran (THF)-soluble component of the toner. The resulting tetrahydrofuran (THF)-soluble component of the toner is dissolved in chloroform to prepare a sample solution having a concentration of 25 mg/mL. 3.5 mL of the resulting sample solution is loaded on the instrument indicated below and fractionation is carried out, using the conditions indicated below, into a release agent-derived lower-molecular-weight component having a molecular weight of less than 2,000 and into a binder resin-derived higher-molecular-weight component having a molecular weight of at least 2,000.

Preparative GPC instrument: preparative HPLC (product name: Model LC-980, Japan Analytical Industry Co., Ltd.)

Preparative column: JAIGEL 3H, JAIGEL 5H (Japan Analytical Industry Co., Ltd.)
Eluent: chloroform
Flow rate: 3.5 mL/min

After fractionation, the solvent is distillatively removed under reduced pressure from each fraction and drying is performed for 24 hours under reduced pressure in a 90° C. atmosphere, and the binder resin-derived higher-molecular-weight component having a molecular weight of at least 2,000 is then designated the binder resin-derived component in the THF-soluble matter (binder resin-derived component 1).

The proportion of the vinyl resin in the binder resin-derived component in the THF-soluble matter is then determined proceeding as follows.

100 mg of the binder resin-derived component 1 is weighed out and dissolved in 3 mL of chloroform. The thusly obtained chloroform-soluble matter is eluted, using chloroform introduced at a flow rate of 3.5 mL/min as the eluent, by preparative HPLC (instrument: LC-9130 NEXT, Japan Analytical Industry Co., Ltd.) using JAIGEL 3H and JAIGEL 5H (Japan Analytical Industry Co., Ltd.) preparative columns.

Using this instrument, the binder resin-derived component 1 is separated into a higher polarity component and a lower polarity component and fractionation is carried out with the higher polarity component being the polyester resin component and the lower polarity component being the vinyl resin component.

After fractionation, the solvent is distilled off under reduced pressure from each fraction and drying is additionally carried out for 24 hours under reduced pressure in a 90° C. atmosphere. The mass of the polyester resin component and the mass of the vinyl resin component are each exactly weighed, and this is divided by the mass (100 mg) of the binder resin-derived component 1 and then multiplied by 100 to yield, respectively, the proportions of the polyester resin and vinyl resin in the fraction having a molecular weight of at least 2,000 as provided by fractionation by preparative GPC from the THF-soluble matter.

In addition, the content of polyester resin having a cyclic structure in the main chain, in the fraction having a molecular weight of at least 2,000 as provided by fractionation using preparative GPC from the THF-soluble matter, is calculated by separating the polyester resin component as follows.

100 mg of the polyester resin component is added to 500 mL of acetone and is completely dissolved by heating to 70° C.; this is followed by gradual cooling to 25° C. to recrystallize the crystalline polyester resin. The crystalline polyester resin is suction filtered to carry out separation into crystalline polyester resin and filtrate.

The separated filtrate is then gradually added to 500 mL of methanol to induce reprecipitation of the polyester resin having a cyclic structure in its main chain. This is followed by recovery, using a suction filter, of the polyester resin having a cyclic structure in its main chain.

The obtained polyester resin having a cyclic structure in its main chain and the crystalline polyester resin are dried under reduced pressure for 24 hours at 40° C. The mass of the polyester resin having a cyclic structure in its main chain and the mass of the crystalline polyester resin are each exactly weighed, and this is divided by the mass (100 mg) of the polyester resin component and then multiplied by 100 to yield, respectively, the proportion of the polyester resin having a cyclic structure in its main chain and the proportion of the crystalline polyester resin.

For the hybrid resin, the proportions of the polyester resin and vinyl resin are determined using NMR as described below.

### Compositional Analysis of the Vinyl Resin

The vinyl resin component was fractionated as described in the section on the proportion of the vinyl resin in the THF-soluble matter of the toner, and this vinyl resin component was used to measure the compositional ratios and mass ratios using nuclear magnetic resonance spectroscopy (NMR).

1 mL of deuterochloroform is added to 20 mg of the sample of the vinyl resin and the proton-NMR spectrum of the dissolved resin is measured. The molar ratio and mass ratio of each monomer can be calculated from the resulting NMR spectrum and the content of each monomer unit can be determined. For example, in the case of a styrene-acrylic copolymer, the compositional ratio and mass ratio can be calculated based on the peak in the vicinity of 6.5 ppm that originates from the styrene monomer and based on the peak in the vicinity of 3.5 to 4.0 ppm that originates from the acrylic monomer.

The following instrumentation and measurement conditions can be used for the nuclear magnetic resonance spectroscopy (NMR).
NMR instrument: Resonance ECX500, JEOL Ltd.
measurement nucleus: proton
measurement mode: single pulse

### Measurement of the Molecular Weight of the Ester Compound by Mass Analysis

### Separation of the Ester Compound From the Toner

The molecular weight of the ester compound in the toner can be determined by measurement of the toner, but the measurement is more preferably performed after carrying out a separation operation.

The toner is dispersed in ethanol, which is a poor solvent for the toner, and the temperature is raised to a temperature above the melting point of the ester compound. Pressure may be applied at this time as necessary. The ester compound, brought to above its melting point by this procedure, is melted and extracted into the ethanol. When pressure is applied in addition to the heating, the ester compound can be separated from the toner by performing solid-liquid separation as such under pressure.

The ester compound is then obtained by drying the extract to solidification. Identification of the ester compound and measurement of its molecular weight can be performed by carrying out pyrolysis GCMS using the following instrumentation and measurement conditions.
mass analysis instrument: ISQ, Thermo Fisher Scientific Inc.
GC instrument: Focus GC, Thermo Fisher Scientific Inc.
ion source temperature: 250° C.
ionization method: EI
mass range: 50 to 1000 m/z
column: HP-5MS [30 m]
pyrolysis instrument: JPS-700 from Japan Analytical Industry Co., Ltd.

A small amount of the ester compound separated by the extraction procedure and 1 µL of tetramethylammonium hydroxide (TMAH) are added to 590° C. pyrofoil. Pyrolysis GCMS measurement is carried out on the prepared sample using the conditions described above to obtain respective peaks for the alcohol component and carboxylic acid component deriving from the ester compound. When this is done, due to the action of the TMAH methylating agent, the alcohol component and carboxylic acid component are detected as the methylation products. The molecular weight of the ester compound can be determined by analysis of the obtained peaks and identification of the structure of the ester compound.

In addition, when the identification and molecular weight measurement are carried out by the direct introduction of the ester compound, this can be carried out, for example, using the instrumentation and measurement conditions given below.
mass analysis instrument: ISQ, Thermo Fisher Scientific Inc.
ion source temperature: 250° C., electron energy: 70 eV
mass range: 50 to 1000 m/z (Cl)
reagent gas: methane (CI)
ionization method: Direct Exposure Probe (DEP), Thermo Fisher Scientific Inc., 0 mA
(10 sec) - 10 mA/sec - 1000 mA (10 sec)

The measurement is run by directly mounting the ester compound separated by the extraction procedure on the filament element of the DEP unit. The molecular ion in the mass spectrum of the main component peak in the vicinity of 0.5 minute to 1 minute in the obtained chromatogram is identified and the ester compound is identified and the molecular weight is determined.

### Method for Measuring the Content of the Ester Compound in the Toner

The content of the ester compound in the toner can be measured using a thermal analyzer (product name: DSC Q2000, TA Instruments Japan Co., Ltd.).

5.0 mg of the toner is introduced into an aluminum pan (Kit No. 0219-0041) sample container and the sample container is mounted in the holder unit and set in the electric oven. The DSC curve is measured with the differential scanning calorimeter (DSC) by heating from 30° C. to 200° C. in a nitrogen atmosphere at a ramp rate of 10° C./minute and the endothermic quantity for the ester compound in the toner is calculated. The endothermic quantity is calculated using the same method and using a 5.0 mg sample of the pure ester compound. The wax content is determined using the following formula and using the endothermic quantities for the ester compound obtained in each of these measurements.

ester compound content in the toner (mass%) = (endothermic quantity for the ester compound in the toner sample (J/g))/(endothermic quantity for the pure ester compound (J/g)) × 100

### Volume-Average Particle Diameter Dv and Particle Diameter Distribution Dv/Dn of the Toner

The volume-average particle diameter Dv, number-average particle diameter Dn, and particle diameter distribution Dv/Dn of the toner is measured using a particle diameter analyzer (product name: Multisizer, Beckman Coulter, Inc.). Measurement with the Multisizer is performed using the following conditions: aperture diameter: 100 µm, dispersion medium: ISOTON II (product name), 10% concentration, number of particles measured: 100,000.

Specifically, 0.2 g of the toner is taken to a beaker and an aqueous alkylbenzenesulfonic acid solution (product name: DRIWEL, Fujifilm Corporation) is added to this as a dispersing agent. 2 mL of the dispersion medium is additionally added to wet the toner, after which 10 mL of the dispersion medium is added, dispersion is carried out for 1 minute using an ultrasound disperser, and the measurement is then performed using the aforementioned particle diameter analyzer.

### Method for Measuring the Melting Point of the Ester Compound

6 mg to 8 mg of the ester compound is measured into the sample holder, and the DSC curve is obtained by carrying out measurement using a differential scanning calorimeter (product name: RDC-220, Seiko Instruments Inc.) and a ramp-up condition of 10° C./min from 0° C. to 150° C. The peak temperature of the endothermic peak in this DSC curve is taken to be the melting point.

### Method for Measuring the Glass Transition Temperature of the Toner

The glass transition temperature of the toner is measured in accordance with ASTM D 3418-97.

Specifically, 10 mg of the toner provided by drying is exactly weighed and is introduced into an aluminum pan. An empty aluminum pan is used as the reference.

Using a differential scanning calorimeter (product name: DSC6220, SII NanoTechnology Inc.), the glass transition temperature of the exactly weighed toner is measured in accordance with ASTM D 3418-97 at a ramp rate condition of 10° C./min in the measurement temperature range from 0° C. to 150° C.

### Method for Measuring the Weight-Average Molecular Weight (Mw) and Peak Molecular Weight (Mp) of, e.g., the Resins

The weight-average molecular weight (Mw) and peak molecular weight (Mp) of the resin are measured as follows using gel permeation chromatography (GPC).

### Preparation of the Measurement Sample

The sample and tetrahydrofuran (THF) are mixed at a concentration of 5.0 mg/mL; standing is carried out for 5 hours to 6 hours at room temperature; and thorough shaking is then carried out and the THF and sample are well mixed until there is no sample aggregation. Additional standing at quiescence at room temperature for at least 12 hours is performed. During this process, the time from the sample + THF mixing starting point to the end point of standing at quiescence is brought to at least 72 hours, to obtain the tetrahydrofuran (THF)-soluble matter of the sample.

A sample solution is then obtained by filtration across a solvent-resistant membrane filter (pore size from 0.45 µm to 0.50 µm, Sample Pretreatment Cartridge H-25-2 [Tosoh Corporation]).

### Measurement of the Sample

Measurement is carried out under the following conditions using the obtained sample solution.
instrument: LC-GPC 150C high-performance GPC instrument (Waters Corporation)
column: 7-column train of Shodex GPC KF-801, 802, 803, 804, 805, 806, and 807
(Showa Denko Kabushiki Kaisha)
mobile phase: THF
flow rate: 1.0 mL/min
column temperature: 40° C.
sample injection amount: 100 µL
detector: RI (refractive index) detector

With regard to measurement of the sample molecular weight, the molecular weight distribution possessed by the sample is calculated from the relationship between the logarithmic value and number of counts in a calibration curve constructed using multiple monodisperse polystyrene reference samples.

The molecular weights of the polystyrene reference samples used to construct the calibration curve are as follows (from Pressure Chemical Co. or Tosoh Corporation): 6.0 × 10², 2.1 × 10³, 4.0 × 10³, 1.75 × 10⁴, 5.1 × 10⁴, 1.1 × 10⁵, 3.9 × 10⁵, 8.6 × 10⁵, 2.0 × 10⁶, and 4.48 × 10⁶.

### Method for Measuring the Average Circularity of the Toner

The average circularity of the toner is measured using an “FPIA-3000” (Sysmex Corporation), a flow particle image analyzer, and using the measurement and analysis conditions from the calibration process.

The specific measurement procedure is as follows.

First, 20 mL of deionized water - from which, e.g., solid impurities, have been removed in advance - is introduced into a glass vessel. To this is added as dispersing agent 0.2 mL of a dilution prepared by the three-fold (mass) dilution with deionized water of “Contaminon N” (a 10 mass% aqueous solution of a neutral pH 7 detergent for cleaning precision measurement instrumentation, comprising a nonionic surfactant, anionic surfactant, and organic builder, from Wako Pure Chemical Industries, Ltd.).

0.02 g of the measurement sample is added and a dispersion treatment is carried out for 2 minutes using an ultrasound disperser to provide a dispersion to be used for the measurement. Cooling is carried out as appropriate during this process in order to have the temperature of the dispersion be from 10° C. to 40° C. Using a “VS-150” (Velvo-Clear Co., Ltd.) benchtop ultrasound cleaner/disperser, which has an oscillation frequency of 50 kHz and an electrical output of 150 W, as an ultrasound disperser, a prescribed amount of deionized water is introduced into the water tank and 2 mL of Contaminon N is added to the water tank.

The aforementioned flow particle image analyzer fitted with a “LUCPLFLN” objective lens (20X, numerical aperture: 0.40) is used for the measurement, and “PSE-900A” (Sysmex Corporation) particle sheath is used for the sheath solution. The dispersion prepared according to the procedure described above is introduced into the flow particle image analyzer and 2000 of the toner are measured in HPF measurement mode and total count mode. The average circularity of the toner is calculated from the results.

### Observation of the Presence/Absence of the Shell on the Toner Particle

Observation of the presence/absence of the shell on the toner particle can be carried out by observation of the state of the toner particle cross section. The specific method for observing the state of the toner particle cross section is as follows.

First, the toner particle is thoroughly dispersed in a photocurable epoxy resin and the epoxy resin is then cured by exposure to ultraviolet radiation. The resulting cured product is sectioned using a microtome equipped with a diamond blade to prepare 100 nm-thick thin-section samples. The samples are optionally stained using ruthenium tetroxide, followed by observation of the toner cross sections using a transmission electron microscope (TEM) (product name: Tecnai TF20XT Electron Microscope, FEI Company) at an acceleration voltage of 120 kV to acquire the TEM images.

When, in this method of observation, the core and shell region are different components, contrast is observed due to the difference in the staining state or due to element mapping. The observation magnification is 20000X.

TOF-SIMS (TRIFT-IV, Ulvac-Phi, Inc.) can be used to confirm whether the resin contained in the shell is at least one resin selected from melamine resins, urea resins, and oxazoline group-bearing vinyl resins.

The analytic conditions are as follows:
Sample preparation: the toner is attached to an indium sheet
Sample pretreatment: none
Primary ion: Au⁺
Acceleration voltage: 30 kV
Charge neutralization mode: On
Measurement mode: Positive
Raster size: 100 µm
Acquisition time: 180 seconds

The execution of this measurement enables detection of the monomer units of thermosetting resin present at the toner surface. Since the shell on the toner surface contains thermosetting resin, the oxazoline group, urea resin, and melamine resin contained in the thermosetting resin can be detected by this measurement. The content of the oxazoline group, urea resin, and melamine resin contained in the thermosetting resin is calculated using a calibration curve constructed based on samples of known concentration, from the intensities in the secondary ion mass spectra (vertical axis: intensity, horizontal axis: mass number = m/z) obtained using the conditions indicated above.

### Dynamic Viscoelastic Measurement on the Toner

An “Ares” (TA Instruments) rotational flat plate rheometer is used as the measurement instrument. A sample provided by compression molding the toner in a 25° C. environment using a tablet molder into a cylindrical shape of diameter = 7.9 mm and thickness = 2.0 ± 0.3 mm is used as the measurement sample. This sample is installed in the parallel plates and the temperature is raised from room temperature (25° C.) to the viscoelastic measurement start temperature (50° C.) and measurement using the following conditions is started.
(1) The sample is set so as to provide an initial normal force of 0.
(2) Parallel plates with a diameter of 7.9 mm are used.
(3) A frequency (Frequency) of 1.0 Hz is used.
(4) The initial value of the applied strain (Strain) is set to 0.1%.
(5) The measurement is carried out at from 25° C. to 160° C. at a ramp rate (Ramp Rate) of 2.0° C./min and a sampling frequency of 1 time/°C.

The measurement is run using the following setting conditions for automatic adjustment mode. The measurement is run in automatic strain adjustment mode (Auto Strain).
(6) The maximum strain (Max Applied Strain) is set to 20.0%.
(7) The maximum torque (Max Allowed Torque) is set to 200.0 g · cm and the minimum torque (Min Allowed Torque) is set to 0.2 g · cm.
(8) The strain adjustment (Strain Adjustment) is set to 20.0% of Current Strain. Automatic tension adjustment mode (Auto Tension) is adopted for the measurement.
(9) The automatic tension direction (Auto Tension Direction) is set to compression (Compression).
(10) The initial static force (Initial Static Force) is set to 10.0 g and the automatic tension sensitivity (Auto Tension Sensitivity) is set to 40.0 g.
(11) For the automatic tension (Auto Tension) operating condition, the sample modulus (Sample Modulus) is equal to or greater than 1.0 × 10³ (Pa).

The loss elastic modulus G″ (Pa) of the toner at 30° C. according to dynamic viscoelastic measurement is taken to be the value of the loss elastic modulus G″ at 30° C. in this measurement.

### Examples

The present invention is specifically described in the following using examples, but the present invention is not limited to or by these examples. The parts in the examples is on a mass basis unless specifically indicated otherwise.

### Polyester Resin 1 Production Example

The following materials were introduced into an autoclave equipped with a pressure-reduction apparatus, a water separation apparatus, a nitrogen gas introduction apparatus, a temperature measurement apparatus, and a stirrer.
Terephthalic acid 32.3 parts (50.0 mol%)
2 mol propylene oxide adduct on bisphenol A 67.7 parts (50.0 mol%)
Potassium titanium oxalate (catalyst) 0.02 parts

A reaction was then run at 220° C. under a nitrogen atmosphere and at normal pressure until the desired molecular weight was reached. Cooling and then pulverization provided a polyester resin 1.

### Crystalline Polyester Resin 1 Production Example

45 mol% diethylene glycol and 55 mol% 1,12-dodecanedioic acid were introduced into a reactor fitted with a nitrogen introduction line, water separation line, stirrer, and thermocouple; tin dioctylate was added as catalyst at 1 part per 100 parts of the total amount of monomer; and a reaction was run for 6 hours while heating to 140° C. in a nitrogen atmosphere and distilling off the water at normal pressure. The reaction was then run while raising the temperature to 200° C. at 10° C./hour; the reaction was run for 2 hours after 200° C. had been reached; and the pressure in the reactor was then reduced to 5 kPa or below and the reaction was run at 200° C. while monitoring the molecular weight to obtain a crystalline polyester resin 1. The weight-average molecular weight (Mw) of the crystalline polyester resin 1 was 35000.

### Crystalline Polyester 2 Production Example

A crystalline polyester resin 2 was obtained proceeding as in the Crystalline Polyester 1 Production Example, but changing the alcohol monomer to 1,9-nonanediol. The weight-average molecular weight (Mw) of the crystalline polyester resin 2 was 36000.

### Vinyl Resin 1 Production Example

The following materials were introduced under a nitrogen atmosphere into a reactor fitted with a reflux condenser, stirrer, thermometer, and nitrogen introduction line.
solvent, toluene 100.0 parts
monomer composition 100.0 parts

(The monomer composition was provided by mixing styrene, n-butyl acrylate, and lauryl acrylate in the proportions given below.)
(82.0 parts styrene)
(12.0 parts n-butyl acrylate)
(6.0 parts lauryl acrylate)
polymerization initiator, t-butyl peroxypivalate (PERBUTYL PV, NOF Corporation) 0.5 parts

While stirring in the aforementioned reactor at 200 rpm, a polymerization reaction was run for 12 hours with heating to 70° C. to obtain a solution in which a polymer of the monomer composition was dissolved in toluene. This solution was then cooled to 25° C. followed by the introduction of the solution while stirring into 1000.0 parts of methanol to precipitate the methanol-insoluble matter. The resulting methanol-insoluble matter was filtered off and was additionally washed with methanol, followed by vacuum drying for 24 hours at 40° C. to yield a vinyl resin 1. The weight-average molecular weight (Mw) of the vinyl resin 1 was 21000.

### Vinyl Resins 2 to 9 Production Example

Vinyl resins 2 to 9 were obtained proceeding as in the Vinyl Resin 1 Production Example, but changing the type and number of parts of the materials as indicated in Table 1.

TABLE 1

| Type | | Vinyl resin 1 | Vinyl resin 2 | Vinyl resin 3 | Vinyl resin 4 | Vinyl resin 5 | Vinyl resin 6 | Vinyl resin 7 | Vinyl resin 8 | Vinyl resin 9 |
|---|---|---|---|---|---|---|---|---|---|---|
| Styrene | Amount of addition (parts) | 82.0 | 82.0 | 82.0 | 82.0 | 82.0 | 82.0 | 82.0 | 82.0 | 82.0 |
| n-butyl acrylate | Amount of addition (parts) | 12.0 | 15.0 | 3.0 | 17.0 | - | 12.0 | 12.0 | 18.0 | 12.0 |
| Formula (1) monomer unit | Type | Lauryl acrylate | Lauryl acrylate | Lauryl acrylate | Lauryl acrylate | Lauryl acrylate | Decyl acrylate | Tetradecyl acrylate | - | Octyl acrylate |
| | Amount of addition (parts) | 6.0 | 3.0 | 15.0 | 1.0 | 18.0 | 6.0 | 6.0 | - | 6.0 |
| | SPm (J/cm³)^{½} | 18.72 | 18.72 | 18.72 | 18.72 | 18.72 | 18.89 | 18.58 | - | 19.13 |
| | Weight-average molecular weight (Mw) | 21000 | 20000 | 20500 | 21000 | 21500 | 21500 | 21000 | 215000 | 210000 |

### Hybrid Vinyl Resin 1 Production Example

A surfactant solution, preliminarily prepared by the dissolution of 2 parts of an anionic surfactant (sodium dodecylbenzenesulfonate: DBS) in 740 parts of deionized water, was introduced into a separable flask fitted with a stirrer, temperature sensor, condenser, and nitrogen introduction apparatus, and the temperature of the charge was raised to 80° C. under a nitrogen current while stirring at a stirring rate of 230 rpm.
Styrene 82.0 parts n-butyl acrylate 12.0 parts
Lauryl acrylate 6.0 parts
Fumaric acid 1.0 part

Otherwise, the preceding materials were mixed and heated to 80° C. to bring about dissolution and produce a monomer solution. The two heated solutions were mixed and dispersed using a mechanical disperser having a circulation line to prepare emulsion particles having a uniform dispersed particle diameter. A solution of 3.3 parts polymerization initiator (potassium persulfate: KPS) dissolved in 350 parts deionized water was then added and heating was carried out for 3 hours at 80° C. and a dispersion of vinyl resin fine particles was obtained by stirring. Additional deionized water was added to this dispersion to adjust the solids fraction (vinyl resin fine particles) to 20 mass% and yield a vinyl resin fine particle dispersion 1.
Terephthalic acid 32.3 parts
2 mol propylene oxide adduct on bisphenol A 67.7 parts (50.0 mol%)

A solution provided by dissolving these materials by stirring for 1 hour at 80° C., was added to the obtained vinyl resin fine particle dispersion 1 and a reaction was run for 12 hours under reflux to obtain a hybrid vinyl resin fine particle dispersion 1. The temperature of this dispersion was then reduced to 25° C., followed by the introduction with stirring of this dispersion into 1000.0 parts of methanol to bring about precipitation of the methanol-insoluble matter. The obtained methanol-insoluble matter was filtered off, washing with additional methanol was performed, and vacuum drying was carried out for 24 hours at 40° C. to obtain a hybrid vinyl resin 1. The weight-average molecular weight (Mw) of hybrid vinyl resin 1 was 35000.

### Ester Compound 1 Production Example

100 parts of behenyl alcohol as alcohol monomer and 80 parts of stearic acid as carboxylic acid monomer were introduced into a reactor fitted with a thermometer, nitrogen introduction line, stirrer, Dean-Stark trap, and Dimroth condenser, and an esterification reaction was run for 15 hours at 200° C.

20 parts toluene and 25 parts isopropanol were added to the obtained ester compound; 190 parts of a 10% aqueous potassium hydroxide solution, a quantity corresponding to 1.5-times the acid value of the ester compound, was added; and stirring was carried out for 4 hours at 70° C. This was followed by removal of the aqueous phase. Washing was performed by introducing 20 parts of deionized water, stirring for 1 hour at 70° C., and then removing the aqueous phase. This washing procedure was repeated until the pH of the removed aqueous phase reached neutrality.

The solvent was then removed by reducing the pressure using conditions of 200° C. and 1 kPa to obtain behenyl stearate (ester compound 1), the behenyl alcohol/stearic acid ester compound that is the ultimate target compound. The properties of the obtained ester compound 1 are given in Table 2.

### Ester Compounds 2 to 5 Production Examples

Ester compounds 2 to 5 were obtained proceeding as in the Ester Compound 1 Production Example, but changing the monomer so as to obtain the compounds in Table 2. The properties of the obtained ester compounds 2 to 5 are shown in Table 2.

TABLE 2

| Ester compound No. | | Structure | SPw (J/cm³)^{½} | Melting point (°C) |
|---|---|---|---|---|
| Ester compound 1 | Behenyl stearate | Formula (4) | 17.57 | 67 |
| Ester compound 2 | Behenyl behenate | Formula (4) | 17.56 | 73 |
| Ester compound 3 | Ethylene glycol distearate | Formula (2) | 18.11 | 76 |
| Ester compound 4 | Dibehenyl sebacate | Formula (3) | 17.94 | 73 |
| Ester compound 5 | Pentaerythritol tetrastearate | - | 18.27 | 77 |

### Crosslinked Resin Fine Particle 1 Production Example

A glass container fitted with a stirrer, condenser, thermometer, and nitrogen introduction line was set in a water bath at a temperature of 80° C. 200 parts of deionized water and 3 parts of surfactant (sodium lauryl sulfate) were subsequently introduced into the container. Then, while stirring the container contents, 1 part ammonium persulfate and 100 parts monomer mixture were each added dropwise to the container, under a nitrogen atmosphere and at a temperature condition of 80° C., over 1 hour at a constant rate. This monomer mixture was a mixture of methyl methacrylate, styrene, and divinylbenzene. The mass ratio among the methyl methacrylate, styrene, and divinylbenzene (methyl methacrylate: styrene: divinylbenzene) in this monomer mixture was 3:1:1.

Then, while stirring the container contents, the container contents were reacted for 1 hour under a nitrogen atmosphere at a temperature condition of 80° C. An emulsion was obtained as a result. The obtained emulsion was subsequently cooled and then dried for 18 hours at a temperature of 80° C. to yield a crosslinked resin fine particle 1. The number-average primary particle diameter of the obtained crosslinked resin fine particle 1 was 120 nm.

### Toner Particle 1 Production Example

Core Particle Production
Vinyl resin 1: 10.0 parts
Polyester resin 1: 90.0 parts
Ester compound 1: 20.0 parts
Crystalline polyester resin 1: 15.0 parts
Fischer-Tropsch wax (HNP51, Nippon Seiro Co., Ltd.): 5.0 parts
Colorant: carbon black (product name: #25B, Mitsubishi Chemical Corporation): 7.0 parts

These materials were pre-mixed using a Henschel mixer (Nippon Coke & Engineering Co., Ltd.) followed by melt-kneading with a twin-screw kneading extruder (Model PCM-30, Ikegai Corporation). The resulting kneaded material was cooled and coarsely pulverized using a hammer mill and was then pulverized using a mechanical pulverizer (T-250, Freund-Turbo Corporation). The resulting finely pulverized powder was classified using a Coanda effect-based multi-grade classifier to yield a core particle having a weight-average particle diameter (D4) of 6.6 µm.

### Shell Formation

A 1-L three-neck flask fitted with a thermometer and a stirring paddle was set in a water bath and 300 g of deionized water was introduced into the flask. The temperature in the flask was then brought to 30° C. using the water bath. An aqueous solution of an oxazoline group-bearing resin (“Epocros WS-300”, Nippon Shokubai Co., Ltd., solids concentration: 10 mass%) was added to the flask in the amount indicated in Table 2. The amount in Table 3 gives the proportion (unit: mass parts) of the oxazoline group-bearing resin (solids) per 100 mass parts of the subsequently added core particles.

300 g of the core particles produced by the above-described procedure was then added to the flask and the contents of the flask were stirred for 1 hour at a stirring rate of 200 min⁻¹. This was followed by the addition of 300 g of deionized water to the flask.

6 mL of an aqueous ammonia solution with a concentration of 1 mass% was subsequently added to the flask. Then, while stirring the contents of the flask at a stirring rate of 150 min⁻¹, the temperature in the flask was raised to 55° C. at a rate of 0.5° C./minute. This temperature (55° C.) was then held for 2 hours while stirring the contents of the flask at a stirring rate of 100 min⁻¹.

The pH of the contents of the flask was thereafter adjusted to 7 by adding an aqueous ammonia solution with a concentration of 1 mass% to the flask. The resulting slurry was cooled to normal temperature (approximately 25° C.).

### Washing Step

The toner particle dispersion obtained proceeding as described above was filtered (solid-liquid separation) using a Buchner funnel. A toner particle wet cake was obtained as a result. The obtained toner particle wet cake was redispersed in deionized water. Toner particle washing was performed by carrying out dispersion and filtration for a total of five times.

### Drying Step

The washed toner particles (powder) were then dispersed in an aqueous ethanol solution having a concentration of 50 mass% to give a toner particle slurry. The toner particles in the slurry were dried using a continuous surface modification device (“Coatmizer” (registered trademark), Freund Corporation) using conditions of a hot current temperature of 45° C. and a blower current of 2 m³/minute. A dried toner particle 1 was obtained as a result.

### Toner Particles 2 to 31 Production Example

Toner particles 2 to 31 were produced proceeding as in the Toner Particle 1 Production Example, but changing the vinyl resin, polyester resin, ester compound, crystalline polyester resin, shell agent, and crosslinked resin fine particle as shown in Table 3.

The Mirbane Resin SM-607 ((product name) Showa Denko Kabushiki Kaisha) used as a shell agent is an aqueous solution of a hexamethylolmelamine initial polymer. The Nikalac MX-280 ((product name) Sanwa Chemical Co., Ltd.) is an alkylated urea resin.

TABLE 3

| Toner particle No. | Vinyl resin | | Polyester resin | | Ester compound | | Crystalline polyester resin | | Release agent HNP51 | Colorant CB | Shell agent | | Crosslinked resin particle | |
|---|---|---|---|---|---|---|---|---|---|---|---|---|---|---|
| | No. | parts | No. | parts | No. | parts | No. | parts | parts | parts | name | parts | No. | parts |
| 1 | 1 | 10.0 | 1 | 90.0 | 1 | 20.0 | 1 | 15.0 | 5.0 | 7.0 | WS-300 | 5.0 | 1 | 2.0 |
| 2 | 1 | 10.0 | 1 | 90.0 | 2 | 20.0 | 1 | 15.0 | 5.0 | 7.0 | WS-300 | 5.0 | 1 | 2.0 |
| 3 | 1 | 10.0 | 1 | 90.0 | 3 | 20.0 | 1 | 15.0 | 5.0 | 7.0 | WS-300 | 5.0 | 1 | 2.0 |
| 4 | 1 | 10.0 | 1 | 90.0 | 4 | 20.0 | 1 | 15.0 | 5.0 | 7.0 | WS-300 | 5.0 | 1 | 2.0 |
| 5 | Hybrid vinyl resin 1 | 100.0 | - | - | 1 | 20.0 | 1 | 15.0 | 5.0 | 7.0 | WS-300 | 5.0 | 1 | 2.0 |
| 6 | 1 | 10.0 | 1 | 90.0 | 1 | 20.0 | 1 | 15.0 | 5.0 | 7.0 | SM-607 | 5.0 | 1 | 2.0 |
| 7 | 1 | 10.0 | 1 | 90.0 | 1 | 20.0 | 1 | 15.0 | 5.0 | 7.0 | MX-280 | 5.0 | 1 | 2.0 |
| 8 | 2 | 10.0 | 1 | 90.0 | 1 | 20.0 | 1 | 15.0 | 5.0 | 7.0 | WS-300 | 5.0 | 1 | 2.0 |
| 9 | 3 | 10.0 | 1 | 90.0 | 1 | 20.0 | 1 | 15.0 | 5.0 | 7.0 | WS-300 | 5.0 | 1 | 2.0 |
| 10 | 4 | 10.0 | 1 | 90.0 | 1 | 20.0 | 1 | 15.0 | 5.0 | 7.0 | WS-300 | 5.0 | 1 | 2.0 |
| 11 | 5 | 10.0 | 1 | 90.0 | 1 | 20.0 | 1 | 15.0 | 5.0 | 7.0 | WS-300 | 5.0 | 1 | 2.0 |
| 12 | 1 | 10.0 | 1 | 90.0 | 1 | 15.0 | 1 | 15.0 | 5.0 | 7.0 | WS-300 | 5.0 | 1 | 2.0 |
| 13 | 1 | 10.0 | 1 | 90.0 | 1 | 10.0 | 1 | 15.0 | 5.0 | 7.0 | WS-300 | 5.0 | 1 | 2.0 |
| 14 | 6 | 10.0 | 1 | 90.0 | 1 | 10.0 | 1 | 15.0 | 5.0 | 7.0 | WS-300 | 5.0 | 1 | 2.0 |
| 15 | 7 | 10.0 | 1 | 90.0 | 1 | 10.0 | 1 | 15.0 | 5.0 | 7.0 | WS-300 | 5.0 | 1 | 2.0 |
| 16 | 6 | 10.0 | 1 | 90.0 | 1 | 10.0 | 2 | 15.0 | 5.0 | 7.0 | WS-300 | 5.0 | 1 | 2.0 |
| 17 | 6 | 10.0 | 1 | 90.0 | 1 | 10.0 | - | - | 5.0 | 7.0 | WS-300 | 5.0 | 1 | 2.0 |
| 18 | 6 | 10.0 | 1 | 90.0 | 1 | 10.0 | - | - | 5.0 | 7.0 | WS-300 | 5.0 | - | - |
| 19 | 6 | 10.0 | 1 | 90.0 | 5 | 10.0 | - | - | 5.0 | 7.0 | WS-300 | 5.0 | - | - |
| 20 | 6 | 10.0 | 1 | 90.0 | - | - | - | - | 15.0 | 7.0 | WS-300 | 5.0 | - | - |
| 21 | 6 | 10.0 | 1 | 90.0 | - | - | - | - | 5.0 | 7.0 | WS-300 | 5.0 | - | - |
| 22 | 6 | 35.0 | 1 | 65.0 | 1 | 10.0 | - | - | 5.0 | 7.0 | WS-300 | 5.0 | - | - |
| 23 | 6 | 1.0 | 1 | 99.0 | 1 | 10.0 | - | - | 5.0 | 7.0 | WS-300 | 5.0 | - | - |
| 24 | 6 | 10.0 | 1 | 90.0 | 1 | 10.0 | - | - | 5.0 | 7.0 | WS-300 | 5.0 | - | - |
| 25 | 6 | 10.0 | 1 | 90.0 | 1 | 10.0 | - | - | 5.0 | 7.0 | WS-300 | 5.0 | - | - |
| 26 | 6 | 10.0 | 1 | 90.0 | 1 | 10.0 | 2 | 15.0 | 5.0 | 7.0 | - | - | 1 | 2.0 |
| 27 | 1 | 10.0 | Crystalline polyester resin 1 | 90.0 | 1 | 20.0 | 1 | 15.0 | 5.0 | 7.0 | WS-300 | 5.0 | 1 | 2.0 |
| 28 | 8 | 10.0 | 1 | 90.0 | 1 | 10.0 | 1 | 15.0 | 5.0 | 7.0 | WS-300 | 5.0 | 1 | 2.0 |
| 29 | 9 | 10.0 | 1 | 90.0 | 1 | 10.0 | 1 | 15.0 | 5.0 | 7.0 | WS-300 | 5.0 | 1 | 2.0 |
| 30 | 1 | 40.0 | 1 | 60.0 | 1 | 20.0 | 1 | 15.0 | 5.0 | 7.0 | WS-300 | 5.0 | 1 | 2.0 |
| 31 | - | 0.0 | 1 | 100.0 | 1 | 20.0 | 1 | 15.0 | 5.0 | 7.0 | WS-300 | 5.0 | 1 | 2.0 |

In the Table, “CB” indicates Carbon black. WS-300 is Epocros WS-300, SM-607 is Mirbane Resin SM-607, and MX-280 is Nikalac MX-280.

### Toner 1 Production Example

3.0 parts of silica fine particles (hydrophobically treated with hexamethyldisilazane, number-average primary particle diameter: 10 nm, BET specific surface area: 170 m²/g) and 2.0 parts of crosslinked resin fine particle 1 were added as external additives per 100 parts of toner particle 1, and mixing was carried out for 15 minutes at 3,000 min⁻¹ using a Henschel mixer (Nippon Coke & Engineering Co., Ltd.) to obtain a toner 1. The properties are given in Table 4.

### Toners 2 to 31 Production Example

Toners 2 to 31 were produced proceeding as in the Toner 1 Production Example, but changing the crosslinked resin fine particle as shown in Table 3. The properties are given in Table 4.

TABLE 4

| TONER | TONER PARTICLE NO. | POLYESTER RESIN CONTENT (MASS%) | VINYL RESIN CONTENT (MASS%) | \|SPM-SPW\| | AVERAGE CIRCULARITY | TONER G″ AT 30° C. (PA) |
|---|---|---|---|---|---|---|
| 1 | 1 | 72 | 8 | 1.15 | 0.950 | 3.1×10⁷ |
| 2 | 2 | 72 | 8 | 1.16 | 0.952 | 3.2×10⁷ |
| 3 | 3 | 71 | 9 | 0.61 | 0.953 | 3.5×10⁷ |
| 4 | 4 | 72 | 8 | 0.78 | 0.956 | 3.3×10⁷ |
| 5 | 5 | 72 | 8 | 1.15 | 0.950 | 4.0×10⁷ |
| 6 | 6 | 71 | 9 | 1.15 | 0.952 | 3.1×10⁷ |
| 7 | 7 | 70 | 10 | 1.15 | 0.957 | 3.0×10⁷ |
| 8 | 8 | 71 | 9 | 1.15 | 0.948 | 4.5×10⁷ |
| 9 | 9 | 71 | 9 | 1.15 | 0.950 | 2.3×10⁷ |
| 10 | 10 | 72 | 8 | 1.15 | 0.946 | 5.1×10⁷ |
| 11 | 11 | 73 | 7 | 1.15 | 0.944 | 1.3×10⁷ |
| 12 | 12 | 71 | 9 | 1.15 | 0.958 | 3.3×10⁷ |
| 13 | 13 | 70 | 10 | 1.15 | 0.961 | 4.0×10⁷ |
| 14 | 14 | 71 | 9 | 1.32 | 0.939 | 4.3×10⁷ |
| 15 | 15 | 70 | 10 | 1.01 | 0.950 | 4.6×10⁷ |
| 16 | 16 | 72 | 8 | 1.32 | 0.953 | 5.1×10⁷ |
| 17 | 17 | 72 | 8 | 1.32 | 0.949 | 5.0×10⁷ |
| 18 | 18 | 73 | 7 | 1.32 | 0.958 | 5.1×10⁷ |
| 19 | 19 | 73 | 7 | 0.62 | 0.950 | 5.2×10⁷ |
| 20 | 20 | 71 | 9 | - | 0.957 | 5.7×10⁷ |
| 21 | 21 | 71 | 9 | - | 0.946 | 5.5×10⁷ |
| 22 | 22 | 52 | 29 | 1.32 | 0.944 | 5.5×10⁷ |
| 23 | 23 | 79 | 1 | 1.32 | 0.958 | 5.8×10⁷ |
| 24 | 24 | 72 | 8 | 1.32 | 0.923 | 5.9×10⁷ |
| 25 | 25 | 73 | 7 | 1.15 | 0.915 | 8.1×10⁷ |
| 26 | 26 | 71 | 9 | 1.15 | 0.954 | 9.1×10⁷ |
| 27 | 27 | 0 | 10 | 1.15 | 0.956 | 1.0×10⁸ |
| 28 | 28 | 71 | 9 | - | 0.953 | 9.7×10⁷ |
| 29 | 29 | 72 | 8 | 1.56 | 0.951 | 8.9×10⁷ |
| 30 | 30 | 48 | 31 | 1.15 | 0.950 | 9.8×10⁷ |
| 31 | 31 | 81 | 0 | - | 0.938 | 1.4×10⁸ |

In the table, the “polyester resin content” is the content of the cyclic structure-bearing polyester resin in the fraction having a molecular weight of at least 2000 as provided by fractionation by preparative GPC from the tetrahydrofuran-soluble matter of the toner. The “vinyl resin content” is the content of the vinyl resin in the fraction having a molecular weight of at least 2000 as provided by fractionation by preparative GPC from the tetrahydrofuran-soluble matter of the toner.

### Toner Property Evaluations

The following evaluations were performed using toners 1 to 31. The results of the evaluations are given in Table 5. The evaluation methods and evaluation criteria used in the present invention are described in the following.

A modified version of an LBP-712Ci (Canon, Inc.) commercial laser printer was used as the image-forming apparatus. This was modified to provide a process speed of 250 mm/sec. A commercial 040H toner cartridge (cyan) (Canon, Inc.) was used as the process cartridge. The production toner was removed from within the cartridge, which, after cleaning with an air blower, was filled with 165 g of toner as described above.

The production toner was removed at each of the yellow, magenta, and black stations, and the evaluations were performed with the yellow, magenta, and black cartridges installed, but with the remaining toner amount detection mechanism inactivated. The various potential settings were changed to enable development with a positive-charging toner.

### Evaluation of Low-Temperature Fixability

The fixing unit was detached from the modified LBP-712Ci laser printer (Canon, Inc.). The various potential settings were changed to enable development with a positive-charging toner, and, using the loaded toner, an unfixed toner image (0.9 mg/cm²) with a length of 2.0 cm × width of 15.0 cm was then formed on image-receiving paper (Office Planner 64 g/m², Canon, Inc.) at a location 1.0 cm from the leading edge with respect to the paper feed direction. The detached fixing unit was then modified to enable adjustment of the fixation temperature and process speed. This was used to carry out a fixing test on the unfixed image.

First, with the process speed set to 250 mm/s and the fixing lineal pressure set to 27.4 kgf, and operating in a normal-temperature, normal-humidity environment (23° C., 60% RH), the unfixed image as described above was fixed using 120° C. for the initial temperature. The solid image was output and speckling was evaluated by examining for the presence/absence of deficits in the black region under 10X magnification using a loupe. The evaluation criteria are given below. The results of the evaluations are given in Table 5.

Evaluation Criteria for Low-Temperature Fixability
A: Speckling is completely absent: 0 locations
B: Under close examination, moderate speckling is seen: from 1 to 3 locations
C: Speckling is observed, but is not conspicuous: from 4 to 6 locations
D: Speckling is conspicuous: at least 7 locations

### Test of Heat-Resistant Storability in a Harsh Environment

For each of the obtained toners 1 to 31, approximately 100 g was introduced into a 1000-mL plastic cup, and this was held for 24 hours in a low-temperature, low-humidity environment (15° C., 10% RH) followed by transition to a high-temperature, high-humidity environment (55° C., 95% RH) over 24 hours. Holding in the high-temperature, high-humidity environment for 24 hours was carried out, followed by transition back to the low-temperature, low-humidity environment (15° C., 10% RH) over 24 hours. The toner was removed after it had been subjected to three cycles of this process.

To evaluate the image quality after standing under these harsh conditions, the cartridge was held for 1 day in the low-temperature, low-humidity environment (15.0° C., 10% RH) and fogging was then evaluated in the same environment. A low-temperature, low-humidity environment facilitates toner charging, provides a broader charge distribution, and facilitates the appearance of fogging, and thus corresponds to a more rigorous evaluation.

With regard to the specifics of the fogging test, a solid white image was output and its reflectance was measured using a Model TC-6DS Reflectometer from Tokyo Denshoku Co., Ltd. The reflectance was also measured in the same manner on the transfer paper (reference paper) prior to formation of the solid white image. A green filter was used for the filter. The fogging was calculated using the following formula from the reflectance values before and after output of the solid white image.

Fogging (reflectance) (%) = reflectance (%) of reference paper - reflectance (%) of white image sample

The criteria for scoring the fogging are given below. The results of the evaluation are given in Table 5.

Criteria for Evaluating the Storability
A: The fogging (reflectance) is less than 1.0%
B: The fogging (reflectance) is at least 1.0%, but less than 1.5%
C: The fogging (reflectance) is at least 1.5%, but less than 2.5%
D: The fogging (reflectance) is at least 2.5%

### Durability Testing Evaluations

Using the cartridge after the execution of the aforementioned harsh environment storability test, and operating in a high-temperature, high-humidity environment (32.5° C., 85% RH), an image output test of 5000 prints per 1 day was run as follows: a horizontal line pattern with a print percentage of 4% was output using 2 prints/1 job; the test was run using a settings mode whereby the machine temporarily stopped between jobs, after which the next job was started; and a total of 20000 prints were made over 4 days. During this period, a solid image and a halftone image were output after the output of each 500 prints, and a visual check was performed for the presence/absence of vertical streaks caused by development member shaving, i.e., the occurrence of development streaking. The results of the evaluations are given in Table 5.

Evaluation Criteria for Development Streaking
A: There was no occurrence of development streaking even at 20,000 prints
B: Development streaking occurred at from 18,001 prints to less than 20,000 prints
C: Development streaking occurred at 16,001 prints to 18,000 prints
D: Development streaking occurred at or below 16,000 prints

A fogging test was carried out when 10,000 prints had been output in the aforementioned image output test. With regard to the specifics of the fogging test, a solid white image was output and its reflectance was measured using a Model TC-6DS Reflectometer from Tokyo Denshoku Co., Ltd. The reflectance was also measured in the same manner on the transfer paper (reference paper) prior to formation of the solid white image. A green filter was used for the filter. The fogging was calculated using the following formula from the reflectance values before and after output of the solid white image.

Fogging (reflectance) (%) = reflectance (%) of reference paper - reflectance (%) of white image sample

The criteria for scoring the fogging are given below. The results of the evaluation are given in Table 5.

Evaluation Criteria for the Durability Test (Fogging)
A: The fogging (reflectance) is less than 1.0%
B: The fogging (reflectance) is at least 1.0%, but less than 1.5%
C: The fogging (reflectance) is at least 1.5%, but less than 2.5%
D: The fogging (reflectance) is at least 2.5%

TABLE 5

| Example No. | Toner No. | Low-temperature fixability (in normal-temperature, normal-humidity environment) | | Heat-resistant storability (in low-temperature, low-humidity environment) | | Durability testing (in high-temperature, high-humidity environment) | | Durability testing (in high-temperature, high-humidity environment) | |
|---|---|---|---|---|---|---|---|---|---|
| | | rank | No. of locations of speckling | rank | Fogging (reflectance) | rank | No. of prints at which vertical streaking appeared | rank | Fogging (reflectance) |
| 1 | 1 | A | 0 | A | 0.2 | A | Not occurred | A | 0.3 |
| 2 | 2 | A | 0 | A | 0.2 | A | Not occurred | A | 0.3 |
| 3 | 3 | A | 0 | A | 0.2 | A | Not occurred | A | 0.3 |
| 4 | 4 | A | 0 | A | 0.2 | A | Not occurred | A | 0.3 |
| 5 | 5 | A | 0 | A | 0.1 | A | Not occurred | A | 0.1 |
| 6 | 6 | A | 0 | A | 0.2 | A | Not occurred | A | 0.3 |
| 7 | 7 | A | 0 | A | 0.2 | A | Not occurred | A | 0.3 |
| 8 | 8 | A | 0 | A | 0.2 | A | Not occurred | A | 0.3 |
| 9 | 9 | A | 0 | A | 0.7 | A | Not occurred | A | 0.8 |
| 10 | 10 | B | 1 | A | 0.2 | A | Not occurred | A | 0.3 |
| 11 | 11 | A | 0 | B | 1.1 | A | Not occurred | B | 1.2 |
| 12 | 12 | A | 0 | A | 0.2 | A | Not occurred | A | 0.3 |
| 13 | 13 | A | 0 | A | 0.2 | A | Not occurred | A | 0.3 |
| 14 | 14 | B | 2 | A | 0.2 | A | Not occurred | A | 0.3 |
| 15 | 15 | B | 2 | A | 0.2 | A | Not occurred | A | 0.3 |
| 16 | 16 | B | 3 | A | 0.2 | A | Not occurred | A | 0.3 |
| 17 | 17 | B | 3 | A | 0.2 | A | Not occurred | A | 0.3 |
| 18 | 18 | B | 3 | A | 0.2 | B | 19000 | B | 1.2 |
| 19 | 19 | C | 5 | B | 1.4 | B | 19000 | B | 1.4 |
| 20 | 20 | C | 5 | B | 1.1 | C | 17000 | B | 1.2 |
| 21 | 21 | C | 6 | B | 1.1 | C | 17000 | B | 1.2 |
| 22 | 22 | B | 2 | C | 2.0 | B | 18500 | C | 2.1 |
| 23 | 23 | C | 5 | B | 1.1 | C | 16500 | B | 1.2 |
| 24 | 24 | C | 5 | B | 1.4 | C | 16500 | B | 1.5 |
| C.E. 1 | 25 | C | 6 | B | 1.4 | D | 12500 | D | 3.1 |
| C.E. 2 | 26 | B | 3 | D | 3.0 | D | 12500 | D | 3.1 |
| C.E. 3 | 27 | B | 3 | C | 2.0 | D | 12500 | C | 2.1 |
| C.E. 4 | 28 | D | 8 | C | 2.0 | D | 12500 | C | 2.1 |
| C.E. 5 | 29 | D | 8 | C | 2.0 | D | 12500 | C | 2.1 |
| C.E. 6 | 30 | D | 8 | D | 3.0 | D | 10000 | D | 3.1 |
| C.E. 7 | 31 | D | 8 | D | 3.0 | D | 10000 | D | 3.1 |

In the Table, “C.E.” indicates “Comparative Example”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2021-171643, filed Oct. 20, 2021, which is hereby incorporated by reference herein in its entirety.

What is claimed is:

1. A toner comprising a toner particle, the toner particle comprising
a core particle containing a binder resin, and
a shell containing a thermosetting resin on the surface of the core particle, wherein
the binder resin comprises at least one of the following (i) and (ii):
(i) a vinyl resin and a polyester resin,
(ii) a hybrid resin in which a vinyl resin and a polyester resin are bonded;
the polyester resin comprises in a main chain thereof a cyclic structure;
a content of the polyester resin having the cyclic structure in a fraction having a molecular weight of at least 2000, as provided by fractionation by preparative GPC from the tetrahydrofuran-soluble matter of the toner, is at least 51 mass%;
the vinyl resin comprises a monomer unit represented by the following formula (1) 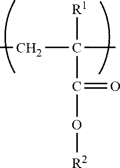
where, in the formula (1), R¹ represents a hydrogen atom or methyl group, and R² represents a straight-chain alkyl group having 10 to 14 carbons;
the thermosetting resin is at least one resin selected from the group consisting of a melamine resin, an urea resin, and a vinyl resin having an oxazoline group; and
the toner has an average circularity of 0.920 to 0.965.

2. The toner according to claim 1, wherein a content of the vinyl resin in the fraction having a molecular weight of at least 2000, as provided by fractionation by preparative GPC from the tetrahydrofuran-soluble matter of the toner, is 1 to 49 mass%.

3. The toner according to claim 1, wherein a content of the monomer unit represented by formula (1) in the vinyl resin is 1.0 to 15.0 mass%.

4. The toner according to claim 1, wherein the toner particle comprises at least one ester compound selected from the group consisting of ester compounds represented by the following formula (2), ester compounds represented by the following formula (3), and ester compounds represented by the following formula (4) 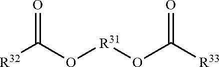 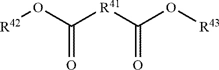 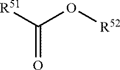
where, in the formulas (2), (3), and (4), R³¹ and R⁴¹ each independently represent an alkylene group having 2 to 8 carbons, and R³², R³³, R⁴², R⁴³, R⁵¹, and R⁵² each independently represent a straight-chain alkyl group having 14 to 24 carbons.

5. The toner according to claim 4, wherein, using SPm (J/cm³)^{½} for the SP value of the monomer unit represented by formula (1), and using SPw (J/cm³)^{½} for the SP value of the ester compound,
SPm is 18.00 to 19.00, and
SPm and SPw satisfy the following formula (a):
$$\left|\text{SPm} - \text{SPw}\right| \leq 1.50$$
.

6. The toner according to claim 1, wherein the toner comprises the toner particle and a crosslinked resin fine particle.

7. The toner according to claim 6, wherein the crosslinked resin fine particle is a fine particle of a styrene-acrylic resin crosslinked by a crosslinking agent.

8. The toner according to claim 1, wherein
the polyester resin is an amorphous polyester resin;
the toner particle further comprises a crystalline polyester resin; and
math sizing
the crystalline polyester resin comprises a monomer unit represented by the following formula (A) and a monomer unit represented by the following formula (B) 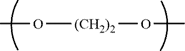 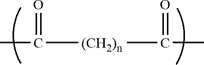
where, in the formula (B), n represents an integer of 4 to 14.
